(19) United States
(12) Patent Application Publication
(10) Pub. No.: US 2006/0291885 A1
(43) Pub. Date: Dec. 28, 2006

(54) Self-lubricating residual toner cleaning apparatus

(75) Inventors: Charles A. Radulski, Macedon, NY (US); David G. Anderson, Ontario, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/159,746

(22) Filed: Jun. 23, 2005

(51) Int. Cl. G03G 21/00

(52) U.S. Cl. 399/71; 399/349; 399/350

(57) ABSTRACT

A self-lubricating residual toner cleaning apparatus is provided and includes (i) a cleaning blade member for removing charged loosened residual toner particles having a first polarity from a toner image bearing surface at a first point; (ii) a disturber fiber brush, mounted at a second point for loosening residual particles from the surface; (iii) a reversible bias source connected to the disturber fiber brush for normally biasing the disturber fiber brush to a second polarity to attract the residual toner particles; and (iv) a controller connected to the reversible bias source for periodically reversing the normally biasing polarity from the second polarity to the first polarity momentarily repelling loosened residual toner particles from the disturber fiber brush back onto the surface, thereby providing a relatively increased amount of residual toner particles on a portion of the surface for contacting and lubricating the cleaning blade member.

The present disclosure relates generally to electrostatographic reproduction machines, and more particularly, concerns such a machine including a self-lubricating residual toner cleaning apparatus.

In a typical toner image reproduction machine, for example an electrostatographic printing process machine, an imaging region of a toner image bearing member such as a photoconductive member is charged to a substantially uniform potential so as to sensitize the surface thereof. The charged portion of the photoconductive member is irradiated or exposed to a light image of an original document being reproduced. Exposure of the charged photoconductive member selectively dissipates the charges thereon in the irradiated areas. This records an electrostatic latent image on the photoconductive member corresponding to the informational areas contained within the original document.

After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated to permanently affix the powder image to the copy sheet. Residual toner particles remaining on the photoconductive surface following image transfer as above are then removed by a cleaning apparatus in order to prepare the surface for forming another toner image.

The foregoing generally describes a typical black and white electrostatographic printing machine. With the advent of multicolor electrophotography, it is desirable to use an image-on-image architecture that comprises a plurality of image forming stations. One example of the plural image forming station architecture utilizes an image-on-image (IOI) system in that the photoreceptive member is recharged, re-imaged and developed for each color separation. This charging, imaging, developing and recharging, re-imaging and developing, all followed by transfer to paper, is done in a single revolution of the photoreceptor in so-called single pass machines, while multi-pass architectures form each color separation with a single charge, image and develop, with separate transfer operations for each color. Again as above, residual toner particles remaining on the photoconductive surface following image transfer as above are then removed by a cleaning apparatus in order to prepare the surface for forming another toner image.

It has been found that image-on-image processes, for example, create very high toner densities on the photoconductive or photoconductive surface. In some machines using toner particles with toner additives in similar multi-color processes, the additional use of control patches, and engagements in component-disturbing activities such as recovery from paper jams, together create conditions that make cleaning or removal of residual toner particles from the imaging region as well as elsewhere very challenging for ordinary conventional cleaning apparatus. In addition, cleaning devices, for example, urethane rubber blades for cleaning the image forming or carrying surface after each use will tend to scratch and abrade the image forming surface where there is insufficient lubrication. Thus it is well known that the image forming surface must be sufficiently lubricated because lack of sufficient lubrication to the edges of such blades may and usually results in scratching and abrasion of the image forming surface. Such scratches and abrasions could rise to a level where they become printable and hence detrimentally affect the quality formed images. The situation is made worse when such conditions are combined with demands for higher process speeds, as well as demands for higher print quality, longer component lives and higher machine reliability.

The following references disclose examples of existing surface cleaning and treating devices. U.S. Pat. No. 5,444,522 issued Aug. 22, 1995 and entitled “Replaceable cleaner subsystem that prevents particle spillage” discloses an apparatus and method for removing the customer replaceable cleaner subsystem from the electrostatographic machine without spillage of toner and other debris particles. The cleaning subsystem is a hybrid of a disturber brush and a retractable cleaning blade. The cleaning unit is slidably inserted or removed from the machine. The cleaning unit is removed from the machine when a cleaning failure occurs and replaced by a readily available spare cleaning unit. When the cleaning unit is inserted into the machine, adjacent to the photoreceptor, the door panel is slidably opened as the cleaning unit is moved into the appropriate space. The blade is moved into an engaged position with the photoreceptor for cleaning the photoreceptor. When the cleaning unit is removed from the printer machine, the blade is retracted and the door panel is slidably closed as the cleaning unit is being removed, providing self-sealing of the cleaner unit and preventing toner and other debris spillage.

U.S. Pat. No. 4,158,498 issued Jun. 19, 1979 an entitled “Blade cleaning system for a reproducing apparatus” discloses a reproducing apparatus that includes a blade cleaning system for removing residual material from an imaging surface. The blade is arranged for movement between a first position wherein an edge thereof engages the imaging surface to remove the residual material, and a second position wherein the edge is spaced from the imaging surface. Responsive to a movement of the blade to the second position a device is provided for removing residual material from the blade edge. A supply of lubricating agent is stored in a suitable container arranged above the device for cleaning the blade edge. A dispensing system is responsive to engagement between the blade and the blade edge cleaning device for dispensing a desired amount of lubricating agent onto the blade edge.

U.S. Pat. No. 5,463,455 issued Oct. 31, 1995 and entitled “Method and apparatus for adaptive cleaner blade lubrication” discloses an adaptive cleaner blade lubricating system for electrophotographic printing machines. In an electrophotographic printing machine, the amount of residual toner available to lubricate a cleaner blade is calculated based on the density of the transferred image. A band of toner is deposited in an inner document gap in selective widths so as to provide an adequate amount of toner to lubricate the cleaner blade across the full width of the photoreceptor. The lubricating band may be variable or may be a constant width with the frequency of placement of the band determined based on average image density for a group of documents. In the preferred embodiment, the width of the toner band is varied as a function of the overall residual toner in each pixel location across the width of the photoreceptor based on the density of the images transferred. As a result of the varying lubrication bands, the cleaner blade is maintained so as to not tuck and cause streaking and/or damage while toner efficiency is maximized.

U.S. Pat. No. 3,983,045 issued Sep. 28, 1976 discloses a developer composition comprising (1) electroscopic toner particles (2) a friction-reducing material of a hardness less than said toner and having greater friction-reducing characteristics than said toner material, and (3) a finely divided non-smearable abrasive material of a hardness greater than said friction-reducing and toner materials. An imaging and development process utilizing the above-identified composition including the step of maintaining the buildup of friction-reducing material on an imaging surface in the submicron range without completely removing or preventing said buildup, by the combined action of a cleaning force wiping at least any residual developed image from at least a portion of said imaging surface.

U.S. Pat. No. 5,463,456 issued Oct. 31, 1995 discloses a photosensitive drum unit for an electrophotographic apparatus, of the type of contacting a cleaning blade to the photosensitive drum in which a cleaning assistant composed of a lubricant capable of lowering the frictionally charged potential of the photosensitive drum caused by the friction of the photosensitive drum and the cleaning blade to not higher than 100 V is attached to the surface of the photosensitive drum, the cleaning blade or both.

U.S. Pat. No. 3,590,000 issued Jun. 29, 1971 discloses a toner with a lubricant additive described as a finely divided, rapid melting toner comprising a colorant, a solid, stable hydrophobic metal salt of fatty acid, a polymeric esterification product of dicarboxylic acid and a diol comprising diphenol.

As can be seen from the above disclosed examples, blade-based cleaning subsystems frequently require some expensive means or additional toner at the cleaning edge of the blade for effective lubrication to reduce blade failures such as scratching and “blade tuck”. Typically this results in poor image quality and a decrease in the expected life of the blade if additional proper lubrication is not maintained. When such additional proper lubrication is provided in the form of fresh clean toner particles as part of the imaging process, or by the addition of additional apparatus, it is costly and expensive because it undesirably consumes toner particles that would otherwise be used to produce customer-related images.

In accordance with one aspect of the present disclosure, there is provided a self-lubricating residual toner cleaning apparatus is provided and includes (i) a cleaning blade member for contacting a moving toner image bearing surface at a first point to remove charged loosened residual toner particles having a first polarity from the toner image bearing surface; (ii) a disturber fiber brush, mounted at a second point upstream of the first point relative to the direction of movement of the moving toner image bearing surface, for loosening residual particles from the moving toner image bearing surface; (iii) a reversible bias source connected to the disturber fiber brush for normally biasing the disturber fiber brush to a second polarity to attract and remove the loosened residual toner particles; and (iv) a controller connected to the reversible bias source for periodically reversing the normally biasing polarity from the second polarity to the first polarity to momentarily repel loosened residual toner particles from the disturber fiber brush onto the toner image bearing surface, thereby providing a relatively increased amount of residual toner particles on a portion of the moving toner image bearing surface for contacting and lubricating the cleaning blade member.

The foregoing and other features of the instant disclosure will be apparent and easily understood from a further reading of the specification, claims and by reference to the accompanying drawings in that:

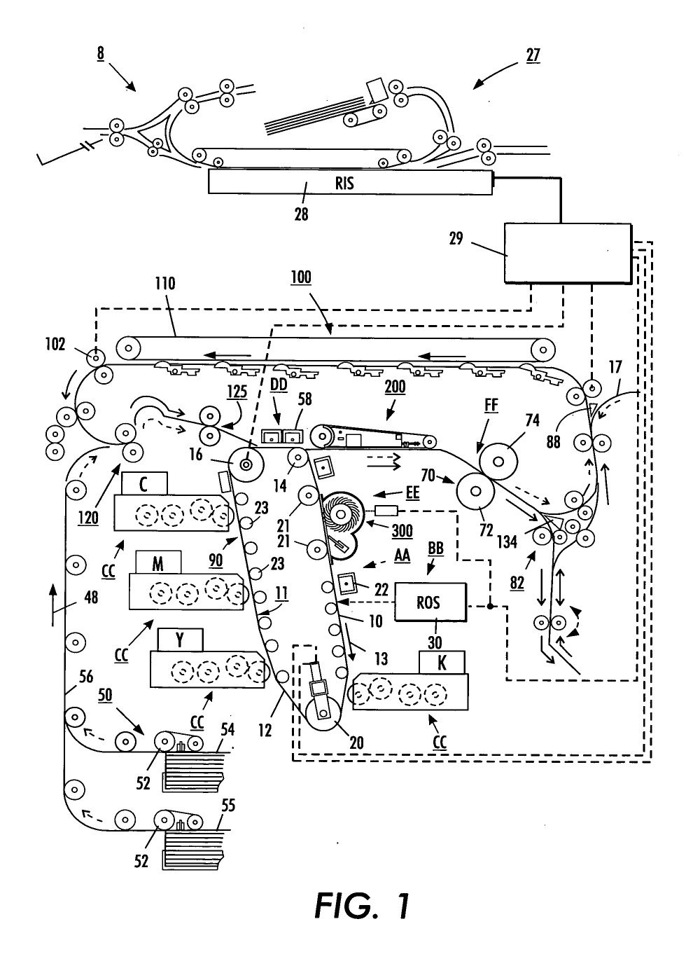

FIG. 1 is a schematic elevational view of an exemplary electrostatographic reproduction machine depicting the self-lubricating residual toner cleaning apparatus of the present disclosure;

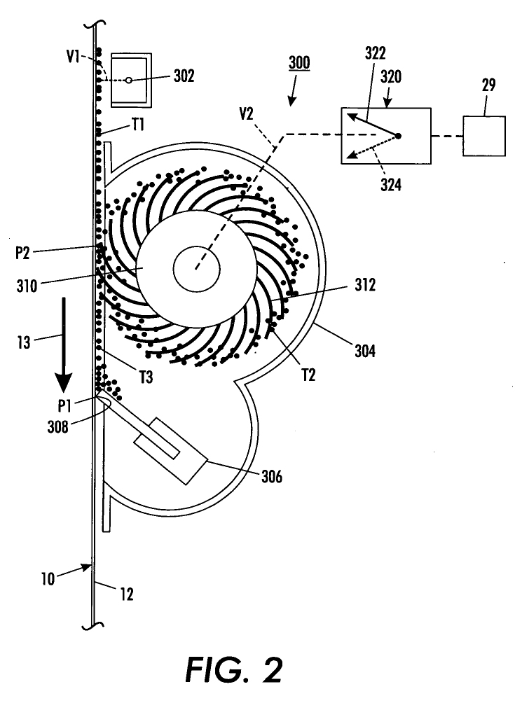

FIG. 2 illustrates a portion of the machine of FIG. 1 showing the self-lubricating residual toner cleaning apparatus of the present disclosure in a cleaning mode; and

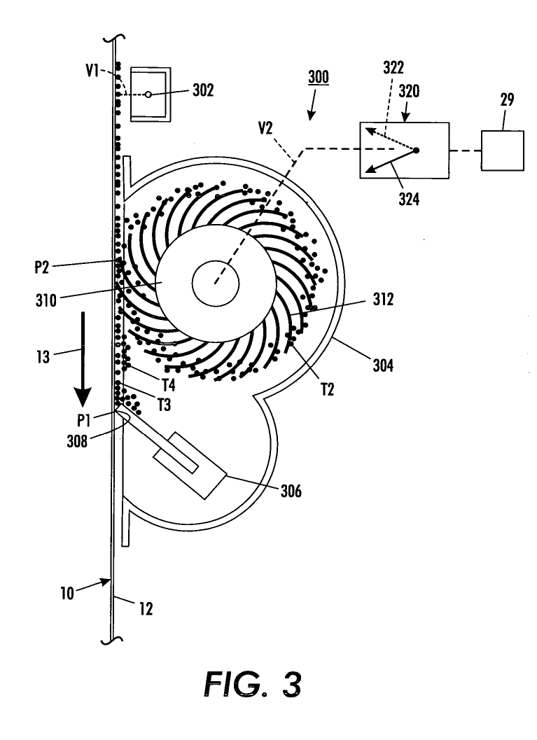

FIG. 3 illustrates a portion of the machine of FIG. 1 showing the self-lubricating residual toner cleaning apparatus of the present disclosure in a self-lubricating mode.

While the present disclosure will be described hereinafter in connection with a preferred embodiment thereof, it should be understood that it is not intended to limit the disclosure to that embodiment. On the contrary, it is intended to cover all alternatives, modifications and equivalents as may be included within the spirit and scope of the disclosure as defined in the appended claims.

Referring first to FIG. 1, it schematically illustrates an electrostatographic reproduction machine 8 that generally employs a photoconductive belt 10 mounted on a belt support module 90. Preferably, the photoconductive belt 10 is made from a photoconductive material coated on a conductive grounding layer that, in turn, is coated on an anti-curl backing layer. Belt 10 moves in the direction of arrow 13 to advance successive portions sequentially through various processing stations disposed about the path of movement thereof. Belt 10 is entrained as a closed loop 11 about stripping roll 14, drive roll 16, idler roll 21, and backer rolls 23.

Initially, a portion of the photoconductive belt surface passes through charging station AA. At charging station M, a corona-generating device indicated generally by the reference numeral 22 charges the photoconductive belt 10 to a relatively high, substantially uniform potential.

As also shown the reproduction machine 8 includes a controller or electronic control subsystem (ESS) 29 that is preferably a self-contained, dedicated minicomputer having a central processor unit (CPU), electronic storage, and a display or user interface (UI). The ESS 29, with the help of sensors and connections, can read, capture, prepare and process image data and machine status information.

Still referring to FIG. 1, at an exposure station BB, the controller or electronic subsystem (ESS), 29, receives the image signals from RIS 28 representing the desired output image and processes these signals to convert them to a continuous tone or gray scale rendition of the image that is transmitted to a modulated output generator, for example the raster output scanner (ROS), indicated generally by reference numeral 30. The image signals transmitted to ESS 29 may originate from RIS 28 as described above or from a computer, thereby enabling the electrostatographic reproduction machine 8 to serve as a remotely located printer for one or more computers. Alternatively, the printer may serve as a dedicated printer for a high-speed computer. The signals from ESS 29, corresponding to the continuous tone image desired to be reproduced by the reproduction machine, are transmitted to ROS 30.

ROS 30 includes a laser with rotating polygon mirror blocks. Preferably a nine-facet polygon is used. At exposure station BB, the ROS 30 illuminates the charged portion on the surface of photoconductive belt 10 at a resolution of about 300 or more pixels per inch. The ROS will expose the photoconductive belt 10 to record an electrostatic latent image thereon corresponding to the continuous tone image received from ESS 29. As an alternative, ROS 30 may employ a linear array of light emitting diodes (LEDs) arranged to illuminate the charged portion of photoconductive belt 10 on a raster-by-raster basis.

After the electrostatic latent image has been recorded on photoconductive surface 12, belt 10 advances the latent image through development stations CC, that include four developer units as shown, containing CMYK color toners, in the form of dry particles. At each developer unit the toner particles are appropriately attracted electrostatically to the latent image using commonly known techniques.

With continued reference to FIG. 1, after the electrostatic latent image is developed, the toner powder image present on belt 10 advances to transfer station DD. A print sheet 48 is advanced to the transfer station DD, by a sheet feeding apparatus 50. Sheet-feeding apparatus 50 may include a corrugated vacuum feeder (TCVF) assembly 52 for contacting the uppermost sheet of stack 54, 55. TCVF 52 acquires each top sheet 48 and advances it to vertical transport 56. Vertical transport 56 directs the advancing sheet 48 through feed rolls 120 into registration transport 125, then into image transfer station DD to receive an image from photoreceptor belt 10 in a timed. Transfer station DD typically includes a corona-generating device 58 that sprays ions onto the backside of sheet 48. This assists in attracting the toner powder image from photoconductive surface 12 to sheet 48. After transfer, sheet 48 continues to move in the direction of arrow 60 where it is picked up by a pre-fuser transport assembly and forwarded to fusing station FF.

Fusing station FF includes a fuser assembly indicated generally by the reference numeral 70 that permanently affixes the transferred toner power image to the copy sheet. Preferably, fuser assembly 70 includes a heated fuser roller 72 and a pressure roller 74 with the powder image on the copy sheet contacting fuser roller 72. The pressure roller is crammed against the fuser roller to provide the necessary pressure to fix the toner powder image to the copy sheet. The fuser roll is internally heated by a quartz lamp (not shown). Release agent, stored in a reservoir (not shown), is pumped to a metering roll (not shown). A trim blade (not shown) trims off the excess release agent. The release agent is transferred to a donor roll (not shown) and then to the fuser roll 72.

The sheet then passes through fuser 70 where the image is permanently fixed or fused to the sheet. After passing through fuser 70, a gate 88 either allows the sheet to move directly via output 17 to a finisher or stacker, or deflects the sheet into the duplex path 100. Specifically, the sheet when to be directed into the duplex path 100, is first passed through a gate 134 into a single sheet inverter 82. That is, if the second sheet is either a simplex sheet, or a completed duplexed sheet having both side one and side two images formed thereon, the sheet will be conveyed via gate 88 directly to output 17. However, if the sheet is being duplexed and is then only printed with a side one image, the gate 88 will be positioned to deflect that sheet into the inverter 82 and into the duplex loop path 100, where it will be inverted and then fed to acceleration nip 102 and belt transports 110, for recirculation back through transfer station DD and fuser 70 for receiving and permanently fixing the side two image to the backside of that duplex sheet, before it exits via exit path 17.

After the print sheet is separated from photoconductive surface 12 of belt 10, the residual toner/developer and paper fiber particles still on and may be adhering to photoconductive surface 12 are then removed therefrom at cleaning station EE in accordance with the present disclosure. Cleaning station EE as illustrated includes the self-lubricating residual toner cleaning apparatus 300 of the present disclosure.

Referring now to FIGS. 1-3, the self-lubricating residual toner cleaning apparatus 300 includes (a) a cleaning blade member 306 for contacting the moving photoreceptor surface 12 at a first point P1 to remove charged loosened residual toner particles T1 having a first polarity V1 from the photoreceptor surface; (b) a disturber fiber brush 310 mounted at a second point P2 upstream of the first point P1 relative to a direction 13 of movement of the photoreceptor surface 12 for loosening residual particles T1 from the photoreceptor or moving toner image bearing surface; (c) a reversible bias source 320 connected to the disturber fiber brush 310 for normally biasing the disturber fiber brush to a second polarity V2 in order to attract and remove the loosened residual toner particles T2, T3 from the photoreceptor surface; and (d) the controller 29 connected to the reversible bias source 320 for periodically reversing the normally biasing polarity from the second polarity V2 to the first polarity V1 to momentarily repel loosened residual toner particles from the disturber fiber brush 310 onto the photoreceptor surface, thereby providing a relatively increased amount of residual toner particles T4 on a portion of the photoreceptor surface upstream of the cleaning blade for contacting and lubricating the cleaning blade member.

The self-lubricating residual toner cleaning apparatus 300 is thus operable in a first cleaning mode as shown in FIG. 2 under the control of the controller 29 for attracting residual toner particles T1 from the surface 12, and in a second residual toner re-depositing mode as shown in FIG. 3 for re-depositing residual toner particles T2 from the disturber fiber brush 310 back onto the surface 12, and at a point P2 upstream of the cleaning blade 306, for contacting and lubricating a cleaning edge 308 of the cleaning blade 306. The reversible bias source comprises a bipolar high voltage power supply. In one possible embodiment, the rotatable disturber fiber brush 310 is mounted for rotating in the same direction as the direction of movement of the photoreceptor surface 12 at the point of contact with the photoreceptor surface. In another embodiment, the self-lubricating residual toner cleaning apparatus 300 may include a pre-clean charging device 302 mounted upstream of the disturber fiber brush 310 relative to the direction of movement of the photoreceptor surface 12 for charging residual toner particles on the surface to a desired single polarity.

Thus in accordance with the present disclosure, reclaimed waste toner T2 already available in the cleaning subsystem is used, without additional apparatus, to perform the lubrication function, eliminating the need for using costly fresh toner in a patch process as well as development steps for such proper blade lubrication. In accordance with the present disclosure, the additional lubrication of the blade 306 is accomplished by the application of a reverse bias 324 to the image disturber brush 310 to cause residual toner T2 in the disturber brush 310 to be deposited upstream of the cleaning blade 306, relative to the direction of movement 13 of the photoreceptor surface 12. The re-deposited increased residual toner (T3+T2) T4 as it comes into contact with the cleaning edge 308 of the cleaning blade 306 thus functions to provide the necessary additional and proper lubrication of the cleaning blade.

To recapitulate, the self-lubricating cleaning subsystem or apparatus 300 of the present disclosure comprises the pre-clean charging device 302, a housing 304, and the primary cleaning element such as the cleaning blade 306. It also comprises the toner particles disturber brush 310 that typically rotates (in the same direction at the point of contact with, as the photoreceptor surface 12) and dislodges residual toner particles T1 from the high attractive electrostatic forces of the photoreceptor surface 12 prior to such loosened particles being removed by the cleaning blade 306. The particles disturber brush 310 also dislodges and loosens carrier beads stuck to the photoreceptor surface, thus preventing them from jamming into edges of the cleaner blade 306. The self-lubricating cleaning subsystem or apparatus 300 further comprises a bipolar high voltage power supply, (HVPS) 320 that is connected to the controller 29 and is controlled to cause the disturber brush 310 to attract or effectively repel the toner particles T2 already on the brush.

During rotation of the disturber fiber brush 310 a quantity of dislodged toner particles T2 coats the fibers 312 of the brush 310 as shown. The bias source 322 connected to the disturber brush 310 normally biases the brush 310 to a second polarity V2 that is opposite to the first polarity V1 of the pre-clean charging device 302, and hence of the toner particles T1 being dislodged. Once the fibers 312 of the brush 310 are saturated or holding as much of the dislodged toner particles T2 they can hold, a scarce rate of loosened or dislodged toner particles T3 will remain on the surface 12 of the photoreceptor and reach the cleaning blade 306 under some printing conditions. As pointed out above, under such conditions a scarce rate of toner particles is often not sufficient for providing the proper lubrication for the cleaning blade 306. Hence an additional quantity of toner particles T4, (which is a sum of the particles T3 that ordinarily would be on the surface 12, plus a re-deposited amount of T2 as above) is needed for such proper lubrication.

Thus in accordance with the present disclosure, the opposite polarity biasing source 324 is also connected to the disturber brush bias supply 320 and both biases 322, 324 are connected to the controller 29 for control as shown. The result is the bipolar high voltage power supply, (HVPS) 320 that is connected to the controller 29 and is controlled to cause the disturber brush 310 to attract or effectively repel the toner particles T2 already on the brush, causing a re-deposition thereof onto the photoreceptor surface 12 in the pre-blade region or upstream of the cleaning blade 306. This procedure can be accomplished as part of a cycle up in order to avoid added control features. The re-deposited toner particles T2 would then be used to provide needed additional lubrication to the blade edge 308, thus eliminating the need for costly fresh toner lubrication stripes generated through additional control steps of the imaging and development subsystems. A reservoir or sump and auger assembly (not shown) collects the cleaned off or removed toner particles T3, T4 from the cleaning blade 306 and transports them to a waste toner bottle for example.

As can be seen, there has been provided a self-lubricating residual toner cleaning apparatus is provided and includes (i) a cleaning blade member for contacting a moving toner image bearing surface at a first point to remove charged loosened residual toner particles having a first polarity from the toner image bearing surface; (ii) a disturber fiber brush, mounted at a second point upstream of the first point relative to the direction of movement of the moving toner image bearing surface, for loosening residual particles from the moving toner image bearing surface; (iii) a reversible bias source connected to the disturber fiber brush for normally biasing the disturber fiber brush to a second polarity to attract and remove the loosened residual toner particles; and (iv) a controller connected to the reversible bias source for periodically reversing the normally biasing polarity from the second polarity to the first polarity to momentarily repel loosened residual toner particles from the disturber fiber brush onto the toner image bearing surface, thereby providing a relatively increased amount of residual toner particles on a portion of the moving toner image bearing surface for contacting and lubricating the cleaning blade member.

It will be appreciated that various of the above-disclosed and other features and functions of this embodiment, or alternatives thereof, may be desirably combined into other different systems or applications. Also that various presently unforeseen or unanticipated alternatives, modifications, variations or improvements therein may be subsequently made by those skilled in the art which are also intended to be encompassed by the following claims.

What is claimed is:

1. A self-lubricating residual toner cleaning apparatus comprising:
(a) a blade member for contacting a moving photoreceptor surface at a first point to remove charged loosened residual toner particles having a first polarity from said photoreceptor surface;
(b) a disturber fiber brush mounted at a second point upstream of said first point relative to a direction of movement of said photoreceptor surface for loosening residual particles therefrom;
(c) a reversible bias source connected to said disturber fiber brush for normally biasing said disturber fiber brush to a second polarity to attract and remove said loosened residual toner particle from said photoreceptor surface; and
(d) a controller connected to said reversible bias source for periodically reversing said normally biasing polarity from said second polarity to said first polarity to momentarily repel loosened residual toner particles from said disturber fiber brush onto said photoreceptor surface, thereby providing a relatively increased amount of residual toner particles on a portion of said photoreceptor surface for contacting and lubricating said blade member.

2. The self-lubricating residual toner cleaning apparatus of claim 1, including a charging device mounted upstream of said disturber fiber brush relative to said direction of movement of said photoreceptor surface for charging residual toner particles on said surface to a desired single polarity.

3. The self-lubricating residual toner cleaning apparatus of claim 1, wherein said reversible bias source comprises a bipolar high voltage power supply.

4. The self-lubricating residual toner cleaning apparatus of claim 1, wherein said rotatable disturber fiber brush is mounted for rotating in the same direction as said surface at a point of contact with said photoreceptor surface.

5. An electrostatographic reproduction machine comprising:
(a) a movable toner image bearing member having an image bearing surface, and a direction of movement;
(b) toner image forming devices mounted along a path of movement of said toner image bearing surface for forming a toner image on said movable toner image bearing surface;
(c) transfer means for transferring said toner image from said movable toner image bearing surface onto a substrate; and
(d) a self-lubricating residual toner cleaning apparatus comprising:
(i) a cleaning blade member for contacting said moving toner image bearing surface at a first point to remove charged loosened residual toner particles having a first polarity from said toner image bearing surface;
(ii) a disturber fiber brush mounted at a second point upstream of said first point relative to said direction of movement of said toner image bearing surface for loosening residual particles therefrom;
(iii) a reversible bias source connected to said disturber fiber brush for normally biasing said disturber fiber brush to a second polarity to attract and remove said loosened residual toner particles from said toner image bearing surface; and
(iv) a controller connected to said reversible bias source for periodically reversing said normally biasing polarity from said second polarity to said first polarity to momentarily repel loosened residual toner particles from said disturber fiber brush onto said toner image bearing surface, thereby providing a relatively increased amount of residual toner particles on a portion of said toner image bearing surface for contacting and lubricating said blade member.

6. The electrostatographic reproduction machine of claim 5, including a charging device mounted upstream of said disturber fiber brush relative to said direction of movement of said photoreceptor surface for charging residual toner particles on said surface to a desired single polarity.

7. The electrostatographic reproduction machine of claim 5, wherein said reversible bias source comprises a bipolar high voltage power supply.

8. The electrostatographic reproduction machine of claim 5, wherein said rotatable disturber fiber brush is mounted for rotating in the same direction as said surface at a point of contact with said photoreceptor surface.
